(19) United States
(12) Patent Application Publication
(10) Pub. No.: US 2015/0150033 A1
(43) Pub. Date: May 28, 2015

(54) SYSTEM AND METHOD FOR BUILDING AND TRACKING AUDIENCE SEGMENTS

(71) Applicant: Fanatical, Inc., Los Angeles, CA (US)

(72) Inventors: GARRETT LAW, Los Angeles, CA (US); TYSON LAW, Los Angeles, CA (US); MATT CORDELL, Los Angeles, CA (US); JOSH MCHUGH, Los Angeles, CA (US)

(73) Assignee: Fanatical, Inc., Los Angeles, CA (US)

(21) Appl. No.: 14/089,657

(22) Filed: Nov. 25, 2013

(51) Int. Cl. H04N 21/442; H04N 21/854

(52) U.S. Cl. CPC H04N 21/44204; H04N 21/854
USPC 725/14

(57) ABSTRACT

A non-transitory computer readable medium having computer executable program code embodied thereon is configured to build a set of individual profiles. Each individual profile includes biographical information and contextual data. The biographical information is associated with a data source, and the contextual data is associated with the data source. The computer executable program code is configured to build an audience segment, wherein the audience segment includes a set of individual profiles. Each individual profile in the audience segment includes biographical information conforming to a set of audience segment criteria and contextual data conforming to the audience segment criteria. The computer executable program code is configured to tag the audience segment with a set of metadata, such that the audience segment can be discretely tracked.

### TECHNICAL FIELD

The present invention relates generally to data tracking and analytics.

### DESCRIPTION OF THE RELATED ART

Previous generation social media analytics platforms provide no way of tracking the engagement of specific or custom segments of activity. Rather, these platforms provide only a broad insight into activities. In addition, previous generation social media engagement platforms provide no way to create a custom segment of people for targeted interaction. Such platforms provide no way to track the effectiveness of engaging with a particular segment or group of social media profiles discretely and apart from other profiles. Moreover, such platforms provide no way for comparing analytics of one custom segment to another custom segment.

In view of these drawbacks, there exists a long-felt need for social media analytics platforms and social media engagement platforms that create custom segments of profiles for discrete tracking, targeted engagement, and granular analytics.

### BRIEF SUMMARY OF EMBODIMENTS OF THE INVENTION

Embodiments of the present invention provide systems and methods for building and tracking audience segments.

One embodiment involves a computer-implemented method for building an audience segment. The method includes building a set of individual profiles. Each individual profile includes biographical information and contextual data. The biographical information is associated with a data source. The contextual data is associated with the data source. The method includes building an audience segment. The audience segment includes a set of individual profiles. Each individual profile in the audience segment includes biographical information conforming to a set of audience segment criteria and contextual data conforming to the audience segment criteria. The method includes tagging the audience segment with a set of metadata, such that the audience segment can be discretely tracked.

In another embodiment, the method includes determining a set of prioritization criteria that select individual profiles to exclude from a clipped audience segment. In another embodiment, the method includes creating the clipped audience segment by excluding from the audience segment individual profiles that, if included in the clipped audience segment, would cause the clipped audience segment to not conform to a set of audience segment limitations. The individual profiles in this embodiment are excluded from the audience segment according to the prioritization criteria.

In a further embodiment, the method includes updating the audience segment by adding an individual profile to the audience segment. The method adds the individual profile in response to a qualifying change in the individual profile. The individual profile was not in the audience segment before the qualifying change. The individual profile did not conform to the audience segment criteria before the qualifying change. The method includes updating the audience segment by removing an individual profile from the audience segment. The method removes the individual profile in response to a disqualifying change in the individual profile. The individual profile was in the audience segment before the disqualifying change. The individual profile conformed to the audience segment criteria before the disqualifying change.

In an additional embodiment, the metadata includes the number of individual profiles in the audience segment, the name of the audience segment, the date the audience segment was built, a manually generated description of the audience segment, an automatically generated description of the audience segment, or an index number.

In another embodiment, the method includes importing an audience segment. In another embodiment, the method includes modifying the audience segment by performing an audience segment modification. The audience segment modification includes modifying the audience segment criteria, modifying the audience limitation criteria, modifying the prioritization criteria, or modifying the metadata used to tag the audience segment.

A further embodiment involves a computer-implemented method for tracking an audience segment. The method includes gathering target data. The target data includes content data that conforms to a set of tracking criteria. The content data is created by a set of data sources. The method includes building an audience segment. The audience segment includes a set of individual profiles. Each individual profile in the audience segment includes biographical information that conforms to a set of audience segment criteria, contextual data that conforms to the audience segment criteria, and target data created by a particular data source. The biographical information is associated with the particular data source. The contextual data is associated with the particular data source. The method includes tagging the audience segment with a set of metadata, such that the audience segment can be discretely tracked.

In one embodiment, the method includes building an audience segment database. The audience segment database includes a set of audience segments. The method includes tracking each audience segment in the audience segment database. In another embodiment, the method includes generating individual profile analytics for each individual profile in the audience segment database. The method includes generating audience segment analytics for each audience segment in the audience segment database.

In another embodiment, the method includes filtering the individual profile analytics and the audience segment analytics using a set of filter metrics. In another embodiment, the method includes comparing the audience segment analytics of one set of audience segments to the audience segment analytics of another set of audience segments in the audience segment database. In another embodiment, the method includes comparing the individual profile analytics of an individual profile in an audience segment to the audience segment analytics of that audience segment. In another embodiment, the method includes initiating an interaction with only the social media accounts associated with individual profiles in a particular audience segment.

One embodiment involves a system for building an audience segment. The system includes a processor. The system includes a least one computer program residing on the processor. The computer program is stored on a non-transitory computer readable medium having computer executable program code embodied thereon. The computer executable program code is configured to build a set of individual profiles. Each individual profile includes biographical information and contextual data. The biographical information is associated with a data source. The contextual data is associated with the data source. The computer executable program code is configured to build an audience segment. The audience segment includes a set of individual profiles. Each individual profile in the audience segment includes biographical information conforming to a set of audience segment criteria and contextual data conforming to the audience segment criteria. The computer executable program code is configured to tag the audience segment with a set of metadata, such that the audience segment can be discretely tracked.

In one embodiment, the computer executable program code is configured to create a clipped audience segment by excluding from the audience segment individual profiles that, if included in the clipped audience segment, would cause the clipped audience segment to not conform to a set of audience segment limitations. In another embodiment, the computer executable program code is further configured build an audience segment database. The audience segment database includes a set of audience segments. The computer executable program code is further configured to track each audience segment in the audience database.

In a further embodiment, the computer executable program code is configured to generate individual profile analytics for each individual profile in the audience segment database. The computer executable program code is configured to generate audience segment analytics for each audience segment in the audience segment database. The computer executable program code is configured to filter the individual analytics and the audience segment analytics using a set of filter metrics.

In an additional embodiment, the computer executable program code is configured to compare the audience segment analytics of one set of audience segments to the audience segment analytics of another set of audience segments in the audience segment database. In another embodiment, the computer executable program code is configured to display the individual profile analytics and the audience segment analytics in graphical format. The computer executable program code is configured to provide a user interface that allows the display of the individual profile analytics and the audience segment analytics to be manipulated.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The present invention, in accordance with one or more various embodiments, is described in detail with reference to the following figures. The figures are provided for purposes of illustration only and merely depict typical or exemplary embodiments of the invention. These figures are provided to facilitate the reader's understanding of the invention and will not be considered limiting of the breadth, scope, or applicability of the invention. It should be noted that for clarity and ease of illustration, these figures are not necessarily made to scale.

FIG. 1 is an exemplary operational flow diagram illustrating a method for building an audience segment.

FIG. 2 is an exemplary operational flow diagram illustrating a method for building an audience segment including creating a clipped audience segment.

FIG. 3 is an exemplary operational flow diagram illustrating a method for building an audience segment including updating an audience segment, importing an audience segment, and modifying an audience segment.

FIG. 4 is an exemplary operational flow diagram illustrating a method for tracking an audience segment.

FIG. 5 is an exemplary operational flow diagram illustrating a method for tracking an audience segment including building an audience segment database and tracking each audience segment in the audience segment database.

FIG. 6 is an exemplary operational flow diagram illustrating a method for tracking an audience segment including generating analytics, filtering analytics, comparing analytics, and initiating an interaction on an audience segment basis.

FIG. 7 illustrates an example computing module that may be used to implement various features of the systems and methods disclosed herein.

The figures are not intended to be exhaustive or to limit the invention to the precise form disclosed. It should be understood that the invention can be practiced with modification and alteration, and that the invention can be limited only by the claims and the equivalents thereof.

### DETAILED DESCRIPTION OF THE EMBODIMENTS OF THE INVENTION

Embodiments of the present invention are directed toward systems and methods for building and tracking an audience segment.

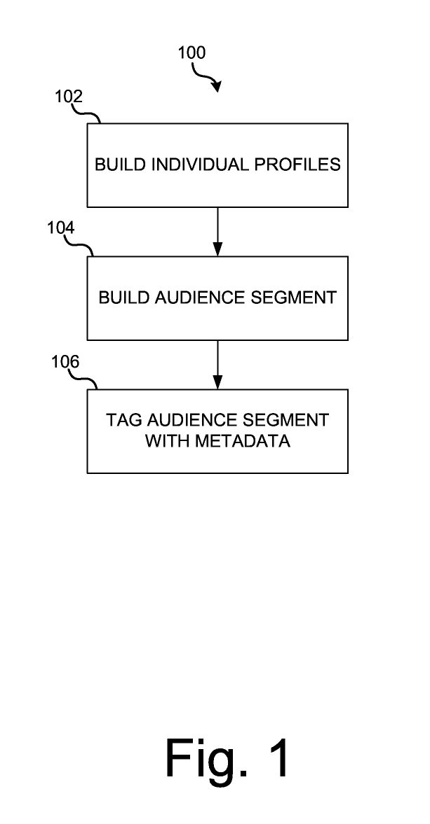

FIG. 1 is an exemplary operational flow diagram illustrating one embodiment of a method 100 for building an audience segment in accordance with the present invention. The method 100 builds 102 individual profiles. The method 100 builds 104 an audience segment. The method 100 tags 106 the audience segment with metadata, such that the audience segment can be discretely tracked. Each of these steps is described in detail below.

The method 100 builds 102 a set of individual profiles. In one embodiment, the method 100 builds 102 each individual profile by creating, storing, and organizing information. The individual profile may include biographical information. Thus, the method 100 may build 102 each individual profile by compiling biographical information from a data source. The data source may include, for example, a social media page associated with an individual, group, or business. Furthermore, actions described herein as being taken by an individual, may be any actions that generate biographical information or contextual data, or that serve as a data source. A data source may include, for example, a web page. A data source may also include an application programming interface (API) or mobile application (app). The data source may include any program or computer transaction that generates information. Accordingly, the biographical information may come from social media accounts; may be public content about an individual, business, or group; or may be proprietary content about an individual, business, or group. The biographical information may include a name, location, age, gender, date of birth, place of birth, website, network size, interests, type and number of social media actions performed, and the like.

The individual profile may include contextual data. Contextual data may include information about when, where, how, and why an individual, group, or business performed certain actions using the data source. For example, the contextual data might concern activities of a social media account, webpage, app, or API. For example, contextual data may include information about the types of blog posts an individual comments on or reads most frequently, and for that matter what the blog post itself said. The contextual data may include data indicating that the individual made certain posts associated with a social media account on a certain date. The contextual data may include the types of products an individual reviews online, may include information about the types of posts the individual performs using one social media platform versus another social media platform, may include information about how long an individual took to respond to a survey, and so on. The contextual data may be available publicly or through third-party data sources, or the contextual data may be available through an API. The contextual data may be associated with a data source.

The method 100 builds 104 an audience segment. The audience segment may include a set of individual profiles. Thus, the method 100 may build 104 an audience segment by associating a set of individual profiles with each other. In one example, the method may do this using a set of audience segment criteria. The audience segment criteria may include criteria pertaining to both the biographical information and the contextual data. For example, a set of audience segment criteria pertaining to biographical information may include a minimum age, a gender, and a minimum network size. Thus, in this example, the audience segment criteria may specifically be defined as a minimum age of 21, a gender of female, and a minimum network size of 1,000. According to method 100, an audience segment built using these exemplary criteria would include all the individual profiles of females over the age of 21 having a network size of 1,000 or more. The method 100 may similarly build 104 an audience segment based solely on audience segment criteria containing specified contextual data, or a combination of contextual data and biographical information.

In one embodiment, the method 100 may build 104 the audience segment using an interactive, online user interface. This interface may be used, for example, to define the audience segment criteria. In one embodiment, the interface may be used to enter various logic operands as part of the audience segment criteria. For example, the logical operands may include NOT, AND, OR, NAND, and so on. The logical operands may operate on the audience segment criteria to form specific search strings. Additionally, the method 100 may use these search strings to build 104 an audience segment in accordance with the audience segment criteria. In one embodiment, the logical operands may be available in the interactive user interface in the form of a drop-down list. Similarly, the interface may contain audience segment criteria that are pre-programmed into drop-down lists.

In one embodiment, the method 100 may build 104 the audience segment automatically, without human intervention. The method 100 may do this by analyzing master profile. In such an example, the method 100 may build 104 the audience segment for the benefit of the master profile. The master profile may be, for example, the profile of a business, such as a restaurant. In one example, this master profile may be associated with the social media profile of a business. Alternatively, the master profile may be associated with a profile that is strictly internal to the business.

Regardless, the method 100 may extract biographical information and contextual data associated with the master profile to create audience segment limitations. As such, once a user creates a master profile, the method 100 may build 104 audience segments without user intervention. In addition, such audience segments may be relevant to the user's interests as embodied in the master profile through the biographical information and contextual data associated with the master profile.

The method 100 tags 106 the audience segment with a set of metadata, such that the audience segment can be discretely tracked. In one embodiment, the method 100 tags 106 the audience segment with metadata by associating the metadata with the audience segment. This may be done by associating the metadata with each individual profile in the audience segment. This may not be necessary in some instances, however, because each individual profile may be associated with the audience segment, and the audience segment itself may be associated with the metadata.

In one embodiment, the metadata may include the number of individual profiles in the audience segment. For example, if a particular audience segment includes 1,000 individual profiles, the method 100 may tag 106 that audience segment with metadata indicating that the size of the audience segment is 1,000.

In one embodiment, the metadata may include the name of the audience segment. In one example, a user may name the audience segment manually when the user specifies the audience segment criteria. In another example, the method 100 may name the audience segment criteria. For example, the user may name an audience segment “People who like the movie Predator.” The method 100 may tag 106 that audience segment with the text of this name. Alternatively, if the method 100 names the audience segment, the method 100 may do so according to, for example, the audience segment criteria.

In one embodiment, the metadata may include the date the audience segment was built. For example, if the method 100 builds 104 the audience segment on Oct. 12, 2013, the method 100 may the audience segment with metadata indicating that the method 100 built 104 the audience segment on Oct. 12, 2013. Alternatively, the metadata may include the date the audience segment was last refreshed.

In one embodiment, the metadata may include a manually generated description of the audience segment. For example, if the method 100 uses the interactive user interface to build 104 the audiences segment, the method 100 may prompt the user to enter a description of the audience segment, which description the user may then enter using the interface. In one embodiment, the metadata may include an automatically generated description of the audience segment. In such an embodiment, the method 100 may include in the description the audience segment criteria, audience segment limitations, and prioritization criteria. The method 100 may generate the description in a way that the audience segment could be reconstructed using only the description (e.g., the description may include all the criteria required to build 104 the audience segment initially).

In one embodiment, the metadata may include an index number. The index number may be any number. However, the index number could also be a number used to strategically organize the audience segments in various ways. One of skill in the art will appreciate various index numbers the method 100 may use.

In other embodiments, the metadata may include statistics, such as the averages associated with the audience segment; may include identifying information for the individual that created the audience segment; may include information about whether the audience segment was created manually or automatically (without intervention); may include a set of permissions associated with the audience segment; and the like.

Because the method 100 tags 106 the audience segment with metadata, the method 100 may discretely track the audience segment. Thus, for example, when the method 100 builds 104 a set of audience segments, the method may use the metadata to specifically identify each audience segment, and to track information associated with each audience segment as discretely identifiable from information associated with other audience segments. Moreover, this may allow the method 100 to compare information associated with different audience segments to the comparison based on different metadata metrics. Alternatively, the method 100 may use a set of metadata to identify a specific a group of audience segments that the method 100 may track. For example, the method 100 may track all audience segments having more than one hundred individual profiles. This allows the method 100 to create a custom audience segment that the method 100 may track over time.

In one embodiment, the method 100 may tag 106 the audience segment with metadata before the method 100 stores the audience segment. In one embodiment, associating the metadata with the audience segment or individual profile may include appending the metadata to the audience segment or individual profile. In one embodiment, appending the metadata may allow the method 100 to index, sort, or filter the audience segment or individual profile, and may make additional information available.

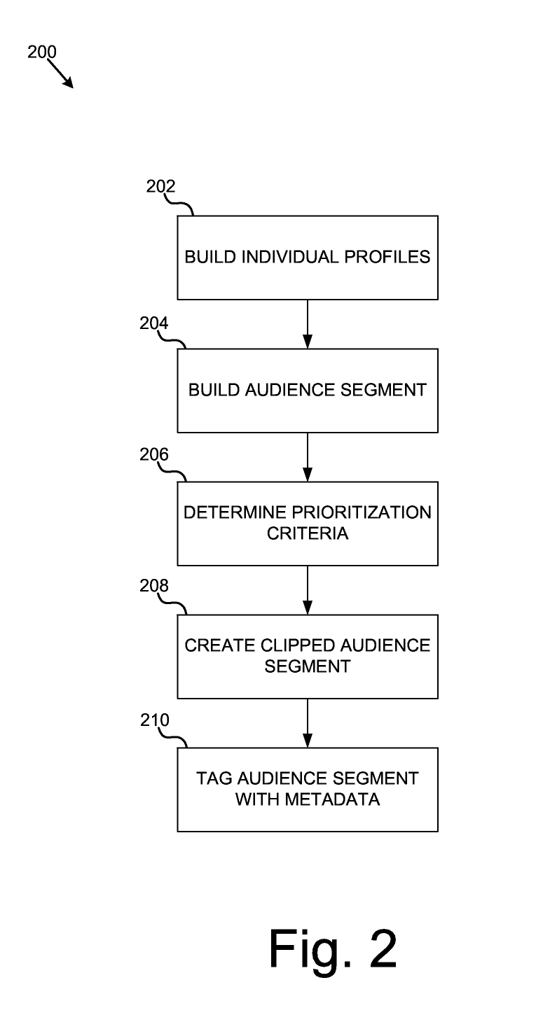

FIG. 2 is an exemplary operational flow diagram illustrating one embodiment of a method 200 for building an audience segment including creating a clipped audience segment in accordance with the present invention. The method 200 builds 202 a set of individual profiles. The method 200 builds 204 an audience segment. The method 200 determines 206 a set of prioritization criteria. The method 200 creates 208 a clipped audience segment. The method 200 tags 210 the audience segment with metadata, such that the audience segment can be discretely tracked. Each of these steps as distinguished from the description of FIG. 1 is described in detail below.

In one embodiment, the method 200 determines 206 a set of prioritization criteria. The prioritization criteria may select individual profiles to exclude from a clipped audience segment. For example, a clipped audience segment may include less individual profiles than an audience segment. This will be described in further detail below. In such an example, the method 200 may need to determine which individual profiles to exclude from the clipped audience segment. The method 200 may use the prioritization criteria to do this. Thus, the prioritization criteria may be used to exclude the largest individual profile (in terms of network size of the individual profile), to exclude the smallest individual profile, to exclude the individual profiles most recently added to the audience segment, to exclude the individual profiles based on their amount of influence (e.g., most influence or least influence), or to exclude the individual profiles based on other factors. In one embodiment, the prioritization criteria may be based on the metadata; alternatively, the prioritization criteria may be based on the audience segment criteria, biographical information, contextual data, and so on.

In one embodiment, the method 200 creates 208 the clipped audience segment by excluding from the audience segment individual profiles that, if included in the audience segment, would cause the clipped audience segment not to conform to a set of audience segment limitations. For example, if one of the audience segment limitations was to limit the clipped audience segment to a maximum of 1,000 individual profiles, and the audience segment includes 1,050 individual profiles, the method 200 may exclude fifty individual profiles form the audience segment. This may be done, for example, using the prioritization criteria as described above. The audience segment limitations may include a size, audience segment criteria, biographical information, contextual data, and so on.

In one embodiment, the method 200 may include a set of management limits. For example, each audience segment the method 200 builds 204 may include the management limits. The management limits may include a frequency with which the audience segment may be updated, clipped, or modified. Thus, for example, the management limits may direct the method 200 to take an action on an hourly, daily, weekly, or monthly basis, and so on.

In one embodiment, the method 200 may specify an audience segment type for each audience segment the method builds 204. In one embodiment, the audience segment type may be dynamic. A dynamic type audience segment may continually process the audience segment criteria to add or delete individual profiles from the dynamic type audience segment based on changes in the biographical information, contextual data, or other information, such as individual profile analytics (described in detail below).

In one embodiment, the audience segment type may be static. For static audience segments, the method 200 may build 204 the static audience segment and not update, modify, or in any way change the static audience segment unless the method 200 receives a request to take such action. This request, in one embodiment, may be come from a user.

In one embodiment, the audience segment type may be manual. For manual audience segment types, the method 200 may build 204 an audience segment. The method 200 may receive a list of individual profiles that the method 200 may add to the audience segment. These individual profiles may be selected from other audience segments and added via a user interface. Alternatively, these individual profiles may be added via their association with known social media profiles or known social handles on the Internet.

In one embodiment, the audience segment type may be imported-connected. For imported-connected audience segment types, the method 200 may build 204 an audience segment. The method 200 may then import or export individual profiles to or from an audience segment. The import or export may be done synchronously or asynchronously, and may be done in a variety of ways, including via an API, a server, a URL encoding, manually, or through a channel 728 (described in detail below).

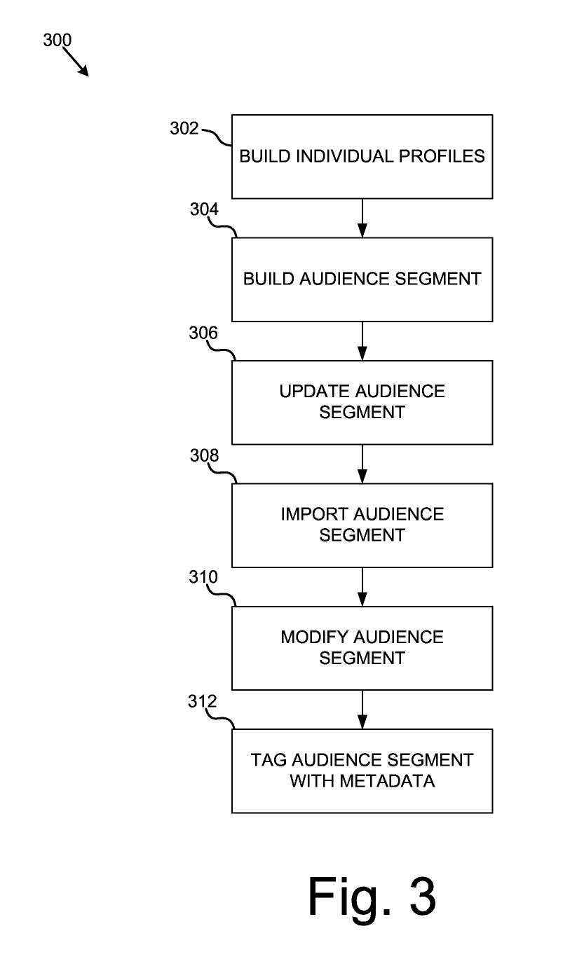

FIG. 3 is an exemplary operational flow diagram illustrating one embodiment of a method 300 for building an audience segment including updating an audience segment, importing an audience segment, and modifying an audience segment in accordance with the present invention. The method 300 builds 302 a set of individual profiles. The method 300 builds 304 an audience segment. The method 300 updates 306 the audience segment. The method 300 imports 308 an audience segment. The method 300 modifies 310 the audience segment. Additionally, the method 300 tags 312 the audience segment with metadata, such that the audience segment can be discretely tracked. Each of these steps as distinguished from the description of FIG. 1 is described in detail below.

In one embodiment, the method 300 updates 306 the audience segment by adding an individual profile to the audience segment in response to a qualifying change in the individual profile. In such an embodiment, the individual profile may not have been included in the audience before the qualifying change. This means that the individual profile did not conform to the audience segment criteria before the qualifying change. The qualifying change may be a change in the biographical information or contextual data associated with the individual profile.

For example, a particular audience segment may include (as a result of the audience segment criteria) only individual profiles having biographical information that indicates the owner of the individual profile is over twenty-one years old. But as owners of individual profiles get older, their biographical information may change to conform to the audience segment limitation. Thus, an owner who turns twenty-one after the method 300 builds 304 the audience segment would, in this example, have undergone a qualifying change. As such, the method 300 may update 306 the audience segment by adding that owner's individual profile to the audience segment. The audience segment criteria of age in this example is illustrative only—the method 300 may update 306 the audience segment in response to any qualifying change. Moreover, the qualifying change may not be associated with audience segment criteria, but may be associated with audience segment limitations, prioritization criteria, or other factors or combination of factors.

In one embodiment, the method 300 updates 306 the audience segment by removing an individual profile from the audience segment in response to a disqualifying change in the individual profile. In such an embodiment, the individual profile was included in the audience segment before the disqualifying change. This means that the individual profile conformed to the audience segment criteria before the disqualifying change. The disqualifying change may be a change in the biographical information or contextual data associated with the individual profile.

For example, a particular audience segment may include (as a result of the audience segment criteria) only individual profiles having biographical information that indicates the owner of the individual profile is under twenty-one years old. But as owners get older, their biographical information may change to not conform to the audience segment limitation. Thus, an owner who turns twenty-one after the method 300 builds 304 the audience segment would, in this example, have undergone a disqualifying change. As such, the method 300 may update 306 the audience segment by removing that owner's individual profile from the audience segment. The audience segment criteria of age in this example is illustrative only—the method 300 may update 306 the audience segment in response to any disqualifying change. Moreover, the disqualifying change may not be associated with audience segment criteria, but may be associated with audience segment limitations, prioritization criteria, or other factors or combination of factors.

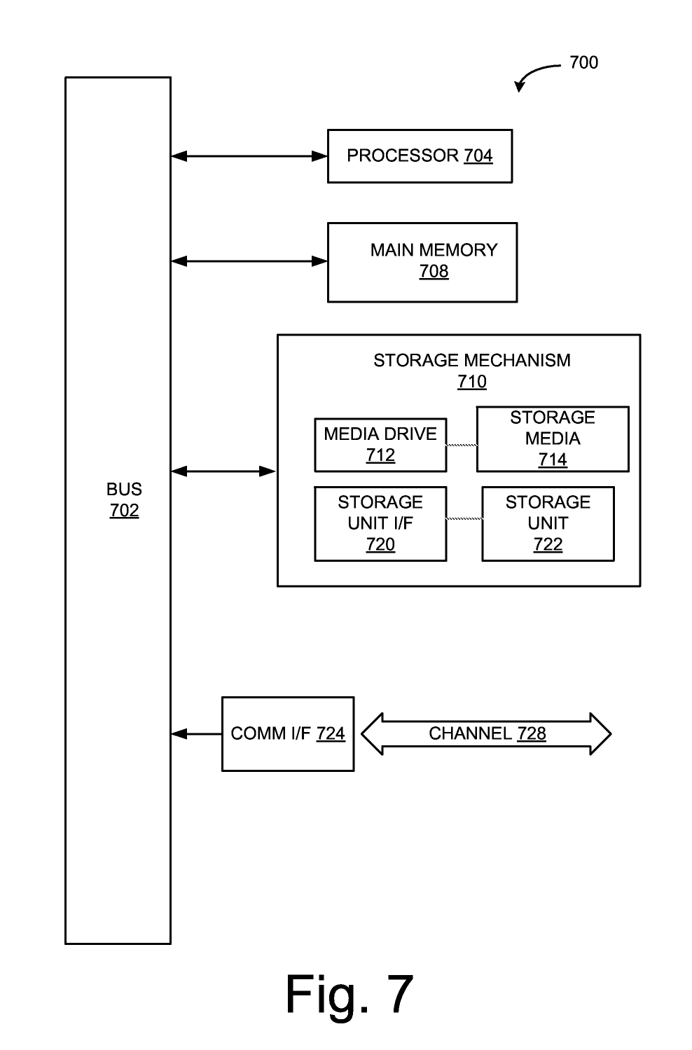

In one embodiment, the method 300 imports 308 an audience segment. The method 300 may import 308 the audience segment in a variety of ways. For example, the method 300 may import 308 the audience segment through any channel 728 described below with reference to FIG. 7. Accordingly, although the method 300 may not have built the imported audience segment, once the method 300 imports 308 the audience segment, the method 300 may perform any number of steps on the audience segment, including any of the steps disclosed herein. For example, the method 300 may update 306 the imported audience segment, may modify 310 the imported audience segment, and so on. In one embodiment, the method 300 may prompt a user who imports the audience segment to perform further functions on the audience segment. These further functions may include, for example, tagging 312 the imported audience segment with metadata, creating a clipped audience segment from the imported audience segment, and so on.

In one embodiment, the method 300 modifies 310 an audience segment by performing an audience segment modification. The audience segment modification may include modifying the audience segment criteria. For example, the method 300 may modify 310 the audience segment by changing a set of audience segment criteria that limits the audience segment to individuals over the age of 21 to limit the audience segment to individuals over the age of 18. In one embodiment, the audience segment modification may include modifying the prioritization criteria. In one embodiment, the audience segment modification may include modifying the metadata with which the audience segment is tagged. In one embodiment, the audience segment modification may include tagging 312 the audience segment with additional metadata.

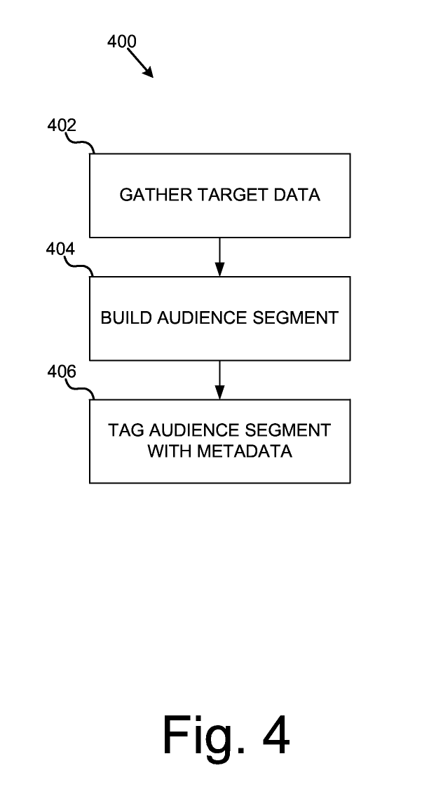

FIG. 4 is an exemplary operational flow diagram illustrating one embodiment of a method 400 for tracking an audience segment in accordance with the present invention. The method 400 gathers 402 target data. The method 400 builds 404 an audience segment. The method 400 tags 406 the audience segment with metadata, such that the audience segment can be discretely tracked. Each of these steps is described below in detail.

In one embodiment, the method 400 gathers 402 target data. The target data may include content data that conforms to a set of tracking criteria. The content data may be any type of data associated with a data source. The content data may be created by a data source. Data sources are described above in detail with regard to the description of FIG. 1. In one embodiment, the content data may include what an individual posted on a particular webpage. For example, if the individual posted on a social media page of The North Face®, the content data may include what that post said. In another example, the content data may include the content of a product review, images posted online, and so on. In one embodiment, the content data may be available through public profiles—for example, social media pages and websites. In one embodiment, the content data may come from external sources, such as third parties who collect the data. In one embodiment, the content data may be private or proprietary, and may be available through, for example, an API or an app.

In one embodiment, the method 400 gathers 402 only the content data that conforms to a set of tracking criteria; the content data that conforms to the tracking criteria may include target data. The tracking criteria may include particular characteristics of the content data that the method 400 may gather 402. For example, the tracking criteria may include reviews of a product where the review rated the product higher than a particular threshold (e.g., more than three stars). The tracking criteria may include, for example, Twitter® posts containing the text “Maui.” The tracking criteria may be descriptive of the content data the method 400 will gather 402—for example, images of sunsets. One of skill in the art will appreciate that the tracking criteria may include any number of characteristics that will distinguish target data from content data (i.e., will distinguish data the method 400 will gather 402 from data the method 400 will not gather). In one embodiment, target data may include all the content data that conforms to a set of tracking criteria. Thus, for example, one set of tracking criteria may define one set of target data while another set of tracking criteria may define another set of target data.

The method 400 may gather 402 target data in a number of ways. In one embodiment, the method 400 may gather 402 the target data by storing the target data in a computing device or database. In another embodiment, the method 400 may not actually store the target data, but may gather 402 the target data by storing pointers or hyperlinks to the target data. One of skill in the art will appreciate the various ways the method 400 may gather 402 target data.

The target data may be created by a set of data sources. A data source may include, for example, a social media page associated with an individual, group or business. A data source may include, for example, a web page. A data source may also include the user of an API or app. The data source may include any program or computer transaction that generates content data. Data sources are described in detail above.

The method 400 builds 404 an audience segment. The audience segment includes a set of individual profiles. Each individual profile in the audience segment includes biographical information that conforms to a set of audience segment criteria. The audience segment criteria may be substantially similar to the audience segment criteria described above with regard to FIG. 1. The biographical information may be associated with a particular data source. The biographical information may be substantially similar to the biographical information described above with regard to FIG. 1.

Each individual profile in the audience segment includes contextual data conforming to the audience segment criteria. The contextual data may be associated with the same particular data source that the biographical information may be associated with. The contextual data may be substantially similar to the contextual data described above with regard to FIG. 1.

Each individual profile in the audience segment includes target data created by the same particular data source associated with the biographical information and the contextual data. While the method 400 may build an audience segment that is somewhat different than that of method 100, the steps of building the audience segments may be substantially similar.

The method 400 tags 406 the audience segment with a set of metadata, such that the audience segment can be discretely tracked. In one embodiment, this step may be substantially similar to how the method 100 tags 106 an audience segment with metadata, such that the audience segment can be discretely tracked.

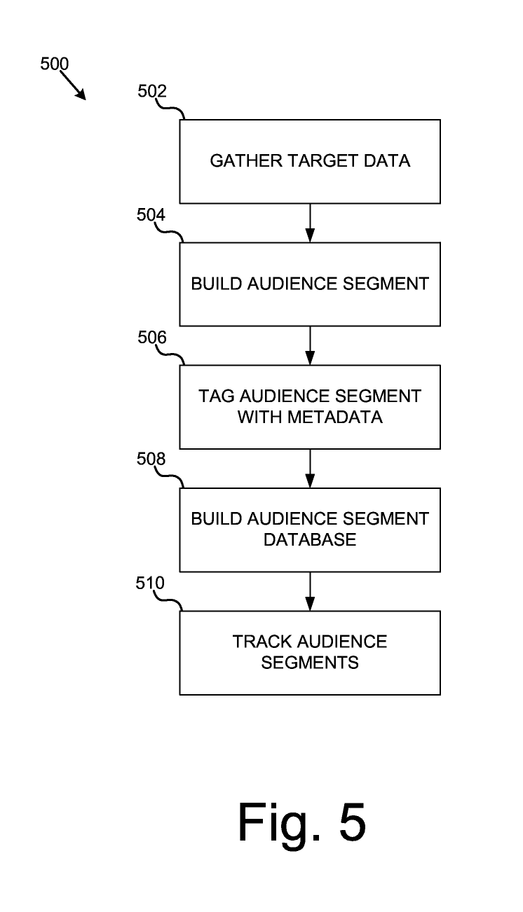

FIG. 5 is an exemplary operational flow diagram illustrating one embodiment of a method 500 for tracking an audience segment including building an audience segment database and tracking an audience segment in accordance with the present invention. The method 500 gathers 502 target data. The method 500 builds 504 an audience segment. The method 500 tags 506 the audience segment with metadata, such that the audience segment can be discretely tracked. The method 500 builds 508 an audience segment database. The method 500 tracks 510 the audience segments in the audience segment database. Each of these steps as distinguished from the description of FIG. 4 is described in detail below.

In one embodiment, the method 500 builds 508 an audience segment database and tracks 510 each audience segment in the audience segment database. The audience segment database includes a set of audience segments. The audience segments in the audience segment database may, for example, have differing audience segment criteria, different tracking criteria, or may differ in other ways. In another embodiment, the audience segments may have substantially the same audience segment criteria, but may differ in other ways.

The audience segment database may include all the information associated with each audience segment in the audience segment database, such as metadata, lists of individual profiles for each audience segment, information about changes in the audience segments, information about the different audience segment criteria for each audience segment, and so on. In one embodiment, the audience database may include groups of audience segments and subgroups of audience segments within those groups. The groups and subgroups may be organized hierarchically by, for example, any of the information in audience segment database.

The method 500 tracks 510 each audience segment in the audience segment database. This tracking may include, for example, discretely tracking information associated with each individual profile in each audience segment, and may include tracking information associated with each audience segment as a whole. The method 500 may track 510 the audience segments in a number of ways. In one embodiment, the method 500 may track 510 the audience segments by storing information associated with the audience segments (including biographical information, contextual data, target data, metadata, and other information in the audience segment database as described above) in a computing device or database. In another embodiment, the method 500 may not actually store the information, but may track 510 the audience segments by storing pointers or hyperlinks to the information. One of skill in the art will appreciate the various ways the method 500 may track 510 the audience segments.

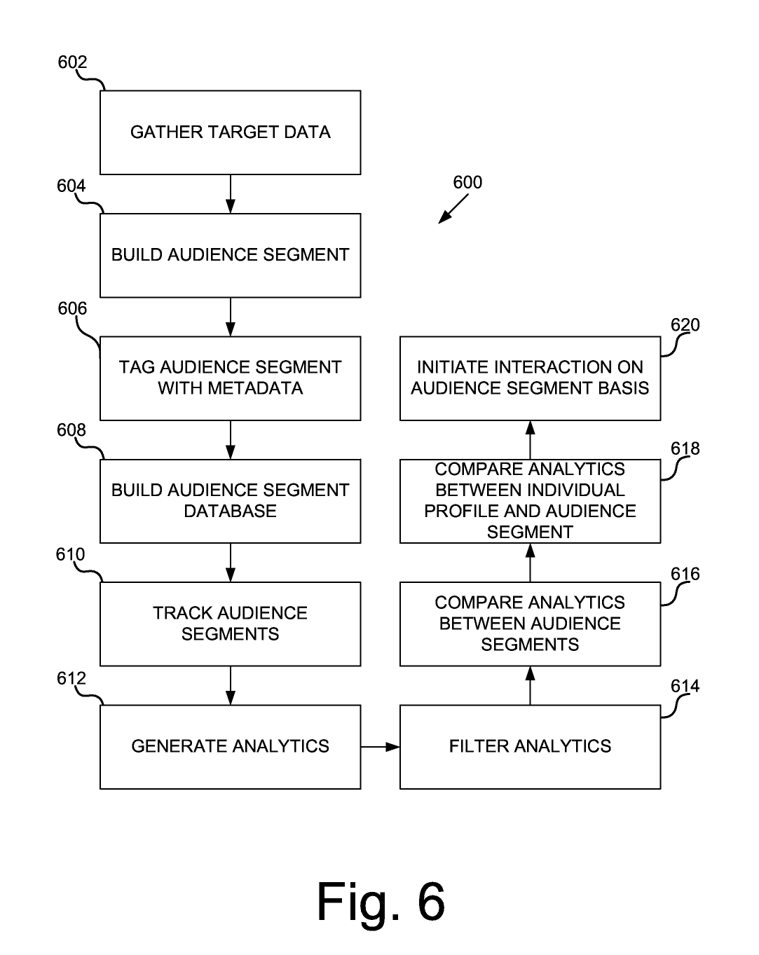

FIG. 6 is an exemplary operational flow diagram illustrating one embodiment of a method 600 for tracking an audience segment including generating analytics, filtering analytics, comparing analytics, and initiating an interaction with only individual profiles in a particular audience segment in accordance with the present invention. The method 600 gathers 602 target data. The method 600 builds 604 an audience segment. The method 600 tags 606 the audience segment with metadata, such that the audience segment can be discretely tracked. The method 600 builds 608 an audience segment database. The method 600 tracks 610 audience segments. The method 600 generates 612 analytics. The method 600 filters 614 analytics. The method 600 compares 616 analytics between audience segments. The method 600 compares 618 analytics between individual profiles and audience segments. The method 600 initiates 620 an interaction on an audience segment basis. Each of these steps as distinguished from the description of FIG. 4 and FIG. 5 is described in detail below.

In one embodiment, the method 600 generates 612 individual profile analytics for each individual profile in the audience segment database and generates 612 audience segment analytics for each audience segment in the audience segment database. The individual profile analytics may include general social media characteristics of the individual profiles in an audience segment. For example, the individual profile analytics may include the number of social media activities associated with an individual profile per unit time (e.g., 5.0 activities per month).

The audience segment analytics may include an aggregation of the individual profile analytics. The audience segment analytics may provide, in one embodiment, perspective into particular brands. For example, the audience segment analytics may indicate that the audience segment as a whole had five activities relating to a particular brand (e.g., The North Face®) last month. The method 600 may generate 612 audience segment analytics, and may generate 612 individual profile analytics, as averages, medians, rolling averages over time, recent averages, totals, standard deviations, performance compared to averages (e.g., for other brands or other audience segments), and so on.

In one embodiment, the method 600 may display both the individual profile analytics and the audience segment analytics such that a user may view the analytics. Such a display, along with a user interface, may allow for the analytics to be manipulated and refined such that desired graphical and analytical relationships are displayed based on various metrics such as tracking criteria, audience segment criteria, brand selections, and so on.

In one embodiment, the method 600 filters 614 the individual profile analytics and the audience segment analytics using a set of filter metrics. For example, if the method 600 uses only one filter metric, and that filter metric is—contains the text “Capricorn”—the method 600 may filter 614 the individual profile analytics such that only the analytics generated for the individual profiles that used the text “Capricorn” may be processed (displayed, calculated, and so on). The filter metrics may include, for example, tracking criteria audience segment criteria, metadata, a number of transactions, a type of transaction, a minimum average or other statistical metrics, text strings, and so on. For example, the method 600 may filter 614 the analytics using the following filter metrics: analytics associated with audience segments including more than 1,000 individual profiles and having more than an average of 5.0 events per month relating to The North Face® over the last six months. This is just one illustration of how the method 600 may filter 614 the analytics. One of skill in the art will recognize the many varieties of ways that the method may 600 filter 614 the analytics. The method 600 may filter 614 audience segment analytics, as well as individual profile analytics, or may filter 614 a combination of the two.

In one embodiment, the method 600 compares 616 the audience segment analytics of one set of audience segments to the audience segment analytics of another set of audience segments in the audience segment database. For example, the method 600 may process, filter, or generate audience segment analytics for two particular audience segments—Segment A and Segment B. The method 600 may then compare 616 the analytics of Segments A and B using various metrics such as tracking criteria audience segment criteria, metadata, a number of transactions, a type of transaction, a minimum average or other statistical metrics, audience segment size and so on. Moreover, the method 600 may compare 616 Segments A and B by, for example, comparing the number of events per month relating to The North Face® over the last six months. This is just one illustration of how the method 600 may compare 616 audience segment analytics. One of skill in the art will recognize the many varieties of ways that the method may 600 compare 616 the analytics between audience segments.

In one embodiment, the method 600 compares 618 the individual profile analytics of one individual profile in an audience segment to the audience segment analytics of that audience segment. This comparison may be substantially similar to the comparison in step 616. Step 618, however, may yield different results that are useful for different reasons. For example, step 618 may provide insight into the usefulness of a particular individual to an audience segment. It may occur, for example, that an individual profile appeared useful because it conformed to the audience segment criteria and tracking criteria. If, however, after time, the comparison 618 yields results that show the individual profile is not useful, the method 600 may exclude that individual profile from the audience segment. For example, if an individual profile does not generate a number of desired events, or does not create desired content data, the method 600 may exclude the individual profile.

In one embodiment, the method 600 initiates 620 an interaction with only the social media accounts associated with individual profiles in a particular audience segment. For example, the method 600 may send a Facebook® message to the accounts of only those individual profiles in a particular audience segment. In this way, the method 600 may provide for targeted communications. For example, the method 600 may build 604 an audience segment that includes only individual profiles that favorably reviewed products from The North Face® online The method 600 may then send messages to the social media accounts associated with only those individual profiles. For example, these messages may contain information about a sale, promotion, event, or other advertisement. By targeting the communication to these individual profiles that favorably reviewed a product, the method 600 may achieve more effective marketing.

FIG. 7 illustrates an example computing module that may be used to implement various features in accordance with the present invention. In one embodiment, the computing module illustrated in FIG. 7 includes a processor and a set of computer programs residing on the processor. The set of computer programs may be stored on a non-transitory computer readable medium having computer executable program code embodied thereon. The computer executable code may be configured to build a set of individual profiles, each individual profile including biographical information and contextual information. The biographical information and contextual information may be associated with a data source.

The computer executable code may be configured to build an audience segment. The audience segment may include a set of individual profiles, with each individual profile including biographical information conforming to a set of audience segment criteria and contextual data conforming to a set of audience segment criteria. The computer executable code may be configured to tag the audience segment criteria with a set of metadata, such that the audience segment can be discretely tracked.

In one embodiment, the computer executable code may be configured to create a clipped audience segment by excluding from the audience segment individual profiles that, if included in the clipped audience segment, would cause the clipped audience segment to not conform to a set of audience segment limitations. In one embodiment, the computer executable code may be configured to build an audience segment database, the audience segment database including a set of audience segments. In one embodiment, the computer executable code may be configured to track each audience segment in the audience segment database.

In one embodiment, the computer executable code may be configured to generate individual profile analytics for each individual profile in the audience segment database. In one embodiment, the computer executable code may be configured to generate audience segment analytics for each audience segment in the audience segment database. In one embodiment, the computer executable code may be configured to filter the individual analytics and the audience segment analytics using a set of filter metrics. In one embodiment, the computer executable code may be configured to compare the analytics of a set of audience segments in the audience segment database to the analytics of another set of audience segments in the audience segment database. In one embodiment, the computer executable code may be configured to display the analytics in graphical format. In one embodiment, the computer executable code may be configured to provide a user interface that allows the display of the individual profile analytics and the audience segment analytics to be manipulated.

In one embodiment, the computer executable code may be configured to display a three-dimensional, virtual audience segment building interface. This three-dimensional display may allow for virtual mixing and matching of audience segment criteria, prioritization criteria, management limits, and so on. For example, the three-dimensional display may show visually the correlation between different audience segments based on the different characteristics of the audience segments. In addition, the display may show how audience segments change in relation to each other when various filter metrics are applied to the audience segments. In one embodiment, the visual sizes of the audience segments may change depending on characteristics of the audience segments. For example, an audience segment may appear as larger in the display if the audience segment includes more individual profiles.

In one embodiment, the computer executable code may be configured to monitor data, including biographical information, contextual data, and content data, to identify individual profiles of particular interest in relation to certain locations or topic-specific events. For example, the computer executable code may be configured to monitor data to determine the most influential individual profiles associated with a discussion about the 2013 MLB World Series. Or, for example, the computer executable code may be configured to monitor data to determine the location in which the most individual profiles are discussing products made by The North Face®.

The example computing module may be used to implement these various features in a variety of ways, as described above with reference to FIGS. 1 through 7, and as will be appreciated by one of ordinary skill in the art.

As used herein, the term module might describe a given unit of functionality that can be performed in accordance with one or more embodiments of the present application. As used herein, a module might be implemented utilizing any form of hardware, software, or a combination thereof. For example, one or more processors, controllers, ASICs, PLAs, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the application are implemented in whole or in part using software, in one embodiment, these software elements can be implemented to operate with a computing or processing module capable of carrying out the functionality described with respect thereto. One such example computing module is shown in FIG. 7. Various embodiments are described in terms of this example-computing module 700. After reading this description, it will become apparent to a person skilled in the relevant art how to implement the application using other computing modules or architectures.

Referring now to FIG. 7, computing module 700 may represent, for example, computing or processing capabilities found within desktop, laptop, notebook, and tablet computers; hand-held computing devices (tablets, PDA's, smart phones, cell phones, palmtops, etc.); mainframes, supercomputers, workstations or servers; or any other type of special-purpose or general-purpose computing devices as may be desirable or appropriate for a given application or environment. Computing module 700 might also represent computing capabilities embedded within or otherwise available to a given device. For example, a computing module might be found in other electronic devices such as, for example, digital cameras, navigation systems, cellular telephones, portable computing devices, modems, routers, WAPs, terminals and other electronic devices that might include some form of processing capability.

Computing module 700 might include, for example, one or more processors, controllers, control modules, or other processing devices, such as a processor 704. Processor 704 might be implemented using a general-purpose or special-purpose processing engine such as, for example, a microprocessor, controller, or other control logic. In the illustrated example, processor 704 is connected to a bus 702, although any communication medium can be used to facilitate interaction with other components of computing module 700 or to communicate externally.

Computing module 700 might also include one or more memory modules, simply referred to herein as main memory 708. For example, preferably random access memory (RAM) or other dynamic memory, might be used for storing information and instructions to be executed by processor 704. Main memory 708 might also be used for storing temporary variables or other intermediate information during execution of instructions to be executed by processor 704. Computing module 700 might likewise include a read only memory (“ROM”) or other static storage device coupled to bus 702 for storing static information and instructions for processor 704.

The computing module 700 might also include one or more various forms of information storage mechanism 710, which might include, for example, a media drive 712 and a storage unit interface 720. The media drive 712 might include a drive or other mechanism to support fixed or removable storage media 714. For example, a hard disk drive, a solid state drive, a magnetic tape drive, an optical disk drive, a CD or DVD drive (R or RW), or other removable or fixed media drive might be provided. Accordingly, storage media 714 might include, for example, a hard disk, a solid state drive, magnetic tape, cartridge, optical disk, a CD or DVD, or other fixed or removable medium that is read by, written to or accessed by media drive 712. As these examples illustrate, the storage media 714 can include a computer usable storage medium having stored therein computer software or data.

In alternative embodiments, information storage mechanism 710 might include other similar instrumentalities for allowing computer programs or other instructions or data to be loaded into computing module 700. Such instrumentalities might include, for example, a fixed or removable storage unit 722 and a storage interface 720. Examples of such storage units 722 and storage interfaces 720 can include a program cartridge and cartridge interface, a removable memory (for example, a flash memory or other removable memory module) and memory slot, a PCMCIA slot and card, and other fixed or removable storage units 722 and storage interfaces 720 that allow software and data to be transferred from the storage unit 722 to computing module 700.

Computing module 700 might also include a communications interface 724. Communications interface 724 might be used to allow software and data to be transferred between computing module 700 and external devices. Examples of communications interface 724 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications interface 724 might typically be carried on signals, which can be electronic, electromagnetic (which includes optical) or other signals capable of being exchanged by a given communications interface 724. These signals might be provided to communications interface 724 via a channel 728. This channel 728 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media such as, for example, main memory 708, storage unit 720, storage media 714, and channel 728. These and other various forms of computer program media or computer usable media may be involved in carrying one or more sequences of one or more instructions to a processing device for execution. Such instructions embodied on the medium are generally referred to as “computer program code” or a “computer program product” (which may be grouped in the form of computer programs or other groupings). When executed, such instructions might enable the computing module 700 to perform features or functions of the present application as discussed herein.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

While various embodiments of the present disclosure have been described above, it should be understood that they have been presented by way of example only, and not of limitation. Likewise, the various diagrams may depict an example architectural or other configuration for the disclosure, which is done to aid in understanding the features and functionality that can be included in the disclosure. The disclosure is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present disclosure. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the application, whether or not such embodiments are described and whether or not such features are presented as being a part of a described embodiment. Thus, the breadth and scope of the present application should not be limited by any of the above-described exemplary embodiments.

What is claimed is:

1. A computer-implemented method for building an audience segment, the method comprising:
building a set of individual profiles, each individual profile comprising biographical information and contextual data, the biographical information associated with a data source, the contextual data associated with the data source;
building an audience segment, the audience segment comprising a set of individual profiles, each individual profile in the audience segment comprising biographical information conforming to a set of audience segment criteria and contextual data conforming to the audience segment criteria; and
tagging the audience segment with a set of metadata, such that the audience segment can be discretely tracked.

2. The method of claim 1, further comprising determining a set of prioritization criteria that select individual profiles to exclude from a clipped audience segment.

3. The method of claim 2, further comprising creating the clipped audience segment by excluding from the audience segment individual profiles that, if included in the clipped audience segment, would cause the clipped audience segment to not conform to a set of audience segment limitations, wherein the individual profiles are excluded from the audience segment according to the prioritization criteria.

4. The method of claim 1, further comprising:
updating the audience segment by adding an individual profile to the audience segment in response to a qualifying change in the individual profile, the individual profile not in the audience segment before the qualifying change, the individual profile not conforming to the audience segment criteria before the qualifying change; and
updating the audience segment by removing an individual profile from the audience segment in response to a disqualifying change in the individual profile, the individual profile in the audience segment before the disqualifying change, the individual profile conforming to the audience segment criteria before the disqualifying change.

5. The method of claim 1, wherein the metadata is selected from the group consisting of the number of individual profiles in the audience segment, the name of the audience segment, the date the audience segment was built, a manually generated description of the audience segment, an automatically generated description of the audience segment, and an index number.

6. The method of claim 1, further comprising importing an audience segment.

7. The method of claim 2, further comprising modifying the audience segment by performing an audience segment modification, the audience segment modification selected from the group consisting of modifying the audience segment criteria, modifying the audience limitation criteria, modifying the prioritization criteria, and modifying the metadata with which the audience segment is tagged.

8. A computer-implemented method for tracking an audience segment, the method comprising:
gathering target data, the target data comprising content data that conforms to a set of tracking criteria, the content data created by a set of data sources;
building an audience segment, the audience segment comprising a set of individual profiles, each individual profile in the audience segment comprising:
biographical information that conforms to a set of audience segment criteria, the biographical information associated with a particular data source;
contextual data that conforms to the audience segment criteria, the contextual data associated with the particular data source; and
target data created by the particular data source; and
tagging the audience segment with a set of metadata, such that the audience segment can be discretely tracked.

9. The method of claim 8, further comprising:
building an audience segment database, the audience segment database comprising a set of audience segments; and
tracking each audience segment in the audience segment database.

10. The method of claim 9, further comprising:
generating individual profile analytics for each individual profile in the audience segment database; and
generating audience segment analytics for each audience segment in the audience segment database.

11. The method of claim 9, further comprising filtering the individual profile analytics and the audience segment analytics using a set of filter metrics.

12. The method of claim 9, further comprising comparing the audience segment analytics of one set of audience segments to the audience segment analytics of another set of audience segments in the audience segment database.

13. The method of claim 9, further comprising comparing the individual profile analytics of an individual profile in an audience segment to the audience segment analytics of that audience segment.

14. The method of claim 8, further comprising initiating an interaction with only the social media accounts associated with individual profiles in a particular audience segment.

15. A system for building an audience segment, the system comprising:
a processor; and
at least one computer program residing on the processor;
wherein the computer program is stored on a non-transitory computer readable medium having computer executable program code embodied thereon, the computer executable program code configured to:
build a set of individual profiles, each individual profile comprising biographical information and contextual data, the biographical information associated with a data source, the contextual data associated with the data source;
build an audience segment, the audience segment comprising a set of individual profiles, each individual profile in the audience segment comprising biographical information conforming to a set of audience segment criteria and contextual data conforming to the audience segment criteria; and
tag the audience segment with a set of metadata, such that the audience segment can be discretely tracked.

16. The system of claim 15, wherein the computer executable program code is further configured to create a clipped audience segment by excluding from the audience segment individual profiles that, if included in the clipped audience segment, would cause the clipped audience segment to not conform to a set of audience segment limitations.

17. The system of claim 15, wherein the computer executable program code is further configured to:
build an audience segment database, the audience segment database comprising a set of audience segments; and
track each audience segment in the audience database.

18. The system of claim 17, wherein the computer executable program code is further configured to:
generate individual profile analytics for each individual profile in the audience segment database;
generate audience segment analytics for each audience segment in the audience segment database; and
filter the individual analytics and the audience segment analytics using a set of filter metrics.

19. The system of claim 17, wherein the computer executable program code is further configured to compare the audience segment analytics of one set of audience segments in the audience segment database to the audience segment analytics of another set of audience segments in the audience segment database.

20. The system of claim 17, wherein the computer executable program code is further configured to:
display the individual profile analytics and the audience segment analytics in graphical format; and
provide a user interface that allows the display of the individual profile analytics and the audience segment analytics to be manipulated.
